(19) United States
(12) Patent Application Publication
(10) Pub. No.: US 2012/0292176 A1
(43) Pub. Date: Nov. 22, 2012

(54) WATER TREATMENT PROCESS

(75) Inventors: Otto Machhammmer, Mannheim (DE); Christian Mueller, Mannheim (DE); Peter Zehner, Weisenheim am Berg (DE)

(73) Assignee: BASF SE, Ludwigshafen (DE)

(21) Appl. No.: 13/576,869

(22) PCT Filed: Feb. 9, 2011
(86) PCT No.: PCT/EP2011/051881

§ 371 Date: Aug. 2, 2012

(30) Foreign Application Priority Data
Feb. 10, 2010 (DE) 10 2010 007 447.0

(51) Int. Cl. C02F 1/14

(52) U.S. Cl. 203/10; 202/153

(57) ABSTRACT

A process and an apparatus for obtaining pure water from seawater, comprising: a) a raw water is provided that comprises at least one non-volatile component (salt), b) the raw water provided is passed as cooling medium into a heat ex-changer, c) additional heat is supplied to the raw water that is heated in the heat exchanger, d) the raw water from step c) is fed to an evaporation zone, e) a carrier gas suitable for water vapour is provided (air), f) the carrier gas is brought into contact with the raw water in counter current flow in the evaporation zone which contains baffles, wherein the carrier gas takes up water vapour from the raw water, g) the raw water that is obtained in step f) that is enriched with the at least one non-volatile component is taken off from the evaporation zone, h) the water vapour- loaded carrier gas from the evaporation zone is fed to the heat exchanger and is cooled in counter current flow to the raw water, wherein the water vapour present in the carrier gas partially condenses out, i) the carrier gas depleted in water vapour is passed out of the heat exchanger, k) the condensed water vapour is taken off from the heat exchanger as pure water, wherein the evaporation zone is operated substantially adiabatically, and wherein the carrier gas is transported by means of natural convection through the evaporation zone and thereafter through the heat exchanger.

The present invention relates to a water treatment process in which pure water is separated off from raw water that comprises non-volatile unwanted components. The present invention relates in particular to a continuous process for obtaining freshwater from salt water and also to an apparatus for continuously obtaining freshwater from salt water.

Water treatment denotes the targeted modification of water quality. This includes in principle two groups of treatment: removing substances from water (e.g. desalting, removal of iron, softening, sterilization or other purification), on the one hand, and also supplementation of substances and setting parameters of the water (e.g. addition of dissolved ions, setting the pH and/or the conductivity) on the other. Water treatment in this case generally serves for obtaining drinking water or service water (today frequently termed process water). Also, desalted or demineralized water is particularly useful for watering plants. Water treatment for generating drinking water acts to meet legal provisions and provisions of standards (e.g. the German drinking water regulation, DIN 2000). Service water is required in large amounts, for example for power stations (as cooling water and feed water), industrial plants, chemical processes, pharmacy, laundries etc. Frequently, very substantial modifications of the water properties are required in water treatment for generating service water and especially diverse process waters.

A special process for water treatment is water desalination. Desalination of salt water designates obtaining service water or drinking water from salt water, especially from seawater, by reducing the salt content. In particular seawater desalination will become of great importance in the future since the supply of all people with clean water will become ever more difficult owing to lack of or pollution of the existing freshwater. The desalination of seawater is used on ships, submarines, islands and in arid coastal countries. Salt water in this case must have only low contamination. In the oil-rich Gulf States, seawater desalination is the main source of obtaining drinking water. Here the drinking water is obtained in gas- or oil-fired desalination plants. In the near East, also, this energy-intensive form of obtaining drinking water is widespread. Combined-cycle gas- and steam-turbine power plants having an attached multistage flash (MSF) evaporation desalination plant are likewise frequently used. On the Canary Islands and the German deep-sea island Helgoland, drinking water is obtained from salt water by the reverse osmosis process.

Membrane processes such as, e.g., reverse osmosis are established processes of water desalination. Of all of the known processes they theoretically require the lowest specific separation energy and the membranes can be produced very inexpensively even today. However, completely deionized water cannot be produced thereby, since some salt always also permeates the membranes. The membranes are in addition both mechanically and chemically sensitive, and so the salt water used must be pretreated. The pretreatment expenditure can exceed the actual separation expenditure. In addition, the membranes have only a limited lifetime. Although the specific separation expenditure is low, a high level of mechanical energy is required for pumping the water.

The efficiency of generation of this energy from primary energy such as, e.g., solar energy, is low, generally in total less than 20%.

Multiple-effect evaporation processes (also referred to as MEV processes) or multistage flash processes (also referred to as MSF processes) are now the most widespread processes for producing freshwater from salt water. MEV and MSF can also be operated using waste heat at below 100° C. and achieve a comparatively high energy utilization factor. The high energy efficiency is achieved by the multistage operation. Each stage, however, is a separate unit having evaporator and condenser and is operated at a separate pressure level. In the MEV process, the brine vaporizes on the evaporator surface. In this process local oversaturation of the brine occurs and salt precipitates out. The evaporator surface can become encrusted by this scaling as it is called. In the MSF process, scaling is avoided by complex forced circulation evaporation. For this purpose each evaporator stage requires a separate, sometimes very large, pump, which must circulate about 10 times the amount of brine by pumping in relation to the amount of freshwater vaporized. This process therefore requires a comparatively very high mechanical energy.

The dewvaporation process is a multistage evaporation process. A carrier gas is used, wherein the heat of condensation of the freshwater is utilized for the partial evaporation of the brine. The heat transport is solely across heat-exchange surfaces, and so correspondingly large heat-exchange surfaces are required. The expenditure on transport of the carrier gas is considerable.

What is termed the Memstill process is a combination of membrane process and MEV process which makes possible theoretically infinitely many stages. Of the theoretically infinitely many stages, however, owing to the non-suppressible axial backmixing of the vapor and the heat streams, in practice, only few may be implemented. The process exhibits the same disadvantages as the abovementioned membrane processes.

DE 19620214 describes a process for desalinating seawater by means of solar energy. This is a multistage evaporation process in which a carrier gas is used. In the process described, the carrier gas must be transported by means of gas compression. The expenditure for transport of the carrier gas is correspondingly high.

WO 02/087721 describes a device for obtaining freshwater by distilling salt water by means of solar energy. As carrier gas, air is used and circulates through the device owing to the thermal effects. Salt water is likewise transported in circulation through the device. By concentrating the salt in the salt water, considerable impairments owing to encrusting of the heat-exchange surfaces may be expected. In addition, with increasing salt content the water vapor pressure decreases and the separation expenditure increases therewith.

DE 102005046643 describes an apparatus for separating a liquid from impurities dissolved therein with a heater and modules arranged in series, each of the modules consisting of a moisturizer and a demoisturizer. Through each module, a blower circulates a carrier gas flow, so that the heat capacity flows in each module are equal. Regulating the heat capacity flows in such a way is very intricate.

DE 102004005689 describes an evaporation method for purifying contaminated liquids using a heater and several complementary pairs arranged in series, each of these complementary pairs consisting of an evaporation element and a condensation element. One or more of these complementary pairs are arranged in a module having a carrier gas circulation system which is circulated by means of a blower. Each module works at a separate pressure level, the pressure levels in the different modules being staged.

Both according to DE 102005046643 and according to DE 102004005689, the operating expense for circulating the carrier gas at a certain pressure level is correspondingly high. Moreover, the technical complexity due to the multi-stage arrangement, the resulting number of modules in contact with saltwater, and the expense for the required heat transfer surface are accordingly high.

The object of the present invention is to provide an improved water treatment process which avoids the disadvantages of the processes known from the prior art. A process shall be provided here that is suitable not only for obtaining drinking water, but also service water for diverse service sectors. The process must not need either complex and expensive salt water pretreatment or a high energy requirement for transporting the streams and shall also be suitable for use in remote regions or in developing countries. A corresponding apparatus must therefore be able to be fabricated using inexpensive materials and nevertheless be reliable in use and insensitive to fouling or scaling.

This object is achieved according to the invention by a continuous process for obtaining pure water from raw water, in which process
a) a raw water is provided that comprises at least one non-volatile component,
b) the raw water provided is passed as cooling medium into a heat exchanger,
c) additional heat is supplied to the raw water that is heated in the heat exchanger,
d) the raw water from step c) is fed to an evaporation zone,
e) a carrier gas suitable for water vapor is provided,
f) the carrier gas is brought into contact with the raw water in countercurrent flow in the evaporation zone, wherein the carrier gas takes up water vapor from the raw water,
g) the raw water that is obtained in step f) that is enriched with the at least one non-volatile component is taken off from the evaporation zone,
h) the water vapor-loaded carrier gas from the evaporation zone is fed to the heat exchanger and is cooled in countercurrent flow to the raw water, wherein the water vapor present in the carrier gas partially condenses out,
i) the carrier gas depleted in water vapor is passed out of the heat exchanger,
k) the condensed water vapor is taken off from the heat exchanger as pure water.

In the process according to the invention, the evaporation zone is operated substantially adiabatically and the carrier gas is transported by means of natural convection through the evaporation zone and thereafter through the heat exchanger.

The process according to the invention serves for the removal from a raw water feed of at least one unwanted contaminant which is non-volatile under the process conditions.

In this case a pure water that is depleted in the unwanted component(s) is obtained. In addition, a raw water enriched with the unwanted component(s) is obtained.

The raw water used according to the invention can comprise at least one non-volatile component in dissolved or non-dissolved form. The non-volatile components present in the raw water can be organic or inorganic substances. The non-volatile components present in the raw water can be liquid or solid under standard conditions (20° C., 1 atm). The non-volatile components are generally distinguished by a very low vapor pressure. Non-dissolved, solid, non-volatile components are preferably present in suspended form in the raw water. Non-dissolved, liquid, non-volatile components are preferably present in dispersed form in the raw water.

Non-volatile components which can be removed by the process according to the invention are, e.g., relatively large solids, floating matter, suspended matter, oils, fats, organic contaminants different from oils and fats, salts, etc. and mixtures thereof.

Since the process according to the invention comprises vaporization of the raw water, it is suitable not only for producing drinking water but also service water for diverse service sectors. Measures that are additionally optionally necessary such as supplementation of dissolved salts in a physiologically compatible amount for treating drinking water are within the expertise of those skilled in the art.

In a special embodiment, the process according to the invention serves for obtaining freshwater from salt water.

A preferred embodiment of the process according to the invention is a continuous process for obtaining freshwater from salt water in which
a) salt water is provided;
b) the salt water provided is passed as cooling medium into a heat exchanger;
c) heat is additionally supplied to the salt water that is heated in the heat exchanger;
d) the salt water of step c) is fed to an evaporation zone;
e) a carrier gas suitable for water vapor is provided;
f) the carrier gas is brought into contact with the salt water in countercurrent flow in the evaporation zone, wherein the carrier gas takes up water vapor from the salt water;
g) the concentrated salt water obtained in step f) is taken off from the evaporation zone;
h) the carrier gas loaded with water vapor is fed from the evaporation zone to the heat exchanger and cooled in countercurrent flow to the salt water, wherein the water vapor present in the carrier gas partly condenses out;
i) the carrier gas that is depleted in water vapor is passed out of the heat exchanger;
k) the condensed water vapor is taken off from the heat exchanger as pure water.

In this embodiment of the novel process too, the evaporation zone is operated substantially adiabatically and the carrier gas is transported by means of natural convection through the evaporation zone and thereafter through the heat exchanger.

Salt water customarily designates a solution of salts in water, e.g. seawater, brackish water, saline river water, or salt-loaded wastewater. The salt content of naturally occurring water such as, for example, in rivers, salt lakes, seas etc., fluctuates just as does the salt content of industrial wastewaters. Waters which are particularly suitable for use in the process according to the invention are brackish water, seawater, industrial wastewater, or mixtures thereof. The salt water used in the process according to the invention has, for example, a salt content of at least 0.5%, preferably at least 1%, particularly preferably at least 3%. Preferably, salt water having a salt content of at most 20% is used, for example having a salt content in the range from 0.1 to 10%, preferably in the range from 2 to 5%.

The salt content of water is reported in the context of the present invention as mass fraction in g/kg of water or in percent. A salt content of 1% is equivalent to 10 g/kg.

Preferably, the salt water used according to the invention comprises at least 1% by weight, based on the total content of salt, of salts of cations and anions. Preferably, the cations are selected from Li⁺, Na⁺, K⁺, NH₄⁺, Ca²⁺, Mg²⁺ and mixtures thereof. Preferably, the anions are selected from F⁻, Cl⁻, Br⁻, I⁻, NO₃⁻, SO₄²⁻, CO₃²⁻and mixtures thereof. Particularly preferably, the salt water used according to the invention comprises at least 50% by weight, especially at least 75% by weight, and in particular at least 90% by weight of NaCl. The salt water used according to the invention can, if desired, comprise salts of divalent, trivalent and/or higher-valent cations and/or anions. These include, in particular, the fractions of customary ions present in the water used. In the provision of salt water for the process according to the invention, optionally a pretreatment of the salt water may be provided. This can be a mechanical prepurification in which the salt water is freed from solids before entry into the heat exchanger. Solids can be removed from the salt water, for example, by means of filtration or in a hydrocyclone. Also, a chemical and/or biological pretreatment can be performed in order to decrease or avoid, for example, the growth of algae, germs etc.

Freshwater, in contrast to salt water, is that fraction of the freely available water on the earth, that is to say not bound, e.g. in plants, in which no salts are dissolved, or salts are dissolved only to a slight extent. Low-salt water having a salt content of less than 0.1%, regardless of its physical state of matter, is described as freshwater.

Freshwater, in the context of the present invention, shall comprise not only process water but also drinking water. Process water (also termed service water or utility water) is water which serves for a specific technical, commercial, agricultural or domestic application. Process water, in contrast to drinking water, is not intended for human consumption, but, however, should correspond to a certain minimum hygiene. In any case it must meet the technological requirements of the respective process. Process water is a type of service water necessary for operating or maintaining an industrial process. Frequently, the salt content of the freshwater used is critical in these applications. Drinking water, in contrast, demands high quality requirements such that it is suitable for human consumption, in particular for drinking and for preparing foods. A certain salt content is required in use as drinking water.

The freshwater obtained according to the invention preferably comprises a salt content of at most 0.1%, preferably in the range from 0.01 to 0.05%. The residual salt content is due, e.g., to droplets entrained from the salt water in the course of the evaporation (step f)).

The carrier gas used in the process according to the invention takes up water vapor by means of temperature elevation and releases it subsequently by reduction in temperature. The carrier gas enriched or saturated with water vapor is hereinafter also termed vapors. All substances and mixtures of substances that are gaseous under the operating conditions of the process according to the invention are in principle suitable as carrier gas. These include, e.g., air, carbon dioxide and nitrogen, and also mixtures thereof. In a preferred embodiment of the process according to the invention, the carrier gas is air. The water content of the carrier gas provided preferably does not exceed 70% by volume. It is for example in the range from 10% by volume to 45% by volume, preferably in the range from 20% by volume to 35% by volume.

In steps b) and h), for condensing pure water, especially freshwater, a suitable countercurrent flow heat exchanger is used. Heat exchangers that are suitable for the process according to the invention in which one medium is a liquid and the other medium is a gas can vary very greatly with respect to the heat capacity per unit volume of the media. Generally—on a volume basis—more gas than liquid must flow through the heat exchanger. In a suitable embodiment, therefore, the raw water, especially the salt water, is conducted as liquid cooling medium in tubes. In an equally suitable embodiment, the exchange surface on the gas side is provided with surface-enlarging structures, such as, e.g., cooling fins or sheets. The heat exchanger is, for example, a tubular heat exchanger, tube-bundle heat exchanger, plate heat exchanger or micro heat exchanger. The heat exchanger is preferably made of a readily available material such as, for example, steel, corrosion-resistant metal alloys, coated materials, plastics, or combinations thereof.

Since the exchange surface facing the gas only comes into contact with vaporized pure water, and therefore somewhat non-critical for possible corrosion, this exchange surface can comprise inexpensive materials, e.g. tin plate, or materials as are used for commercially available air coolers. This applies especially to a desalination process in which the exchange surface facing the gas only comes into contact with desalinated water.

For the region of the heat exchanger which comes into contact with the corrosive raw water, especially salt water, generally corrosion-resistant materials are used. Such materials are known to those skilled in the art. These materials include metals, such as stainless steels, bronzes etc. Preferably, for the heat exchanger, a non-corrosion-resistant but inexpensive metal is used and the regions of the heat exchanger that are contacted by salt water are coated, for example with a corrosion-resistant plastic, or oxides or ceramics. The coating is expediently chosen in such a manner that it has a thermal resistance as low as possible and in addition is resistant to deposits, scaling and fouling.

Alternatively thereto, it is also possible to use a non-corrosion-resistant, but cheap, material in the heat exchanger which is then replaced in relatively short intervals.

The selection, dimensioning, and design of suitable heat exchangers are known to those skilled in the art.

All feed and return tubes can comprise a readily available material such as, for example, steel, corrosion-resistant metal alloys, coated materials, plastics or combinations thereof. Preferably, the tubes are made of plastic.

The additional heat supply in step c) can be performed in any desired manner that is suitable for heating raw water, especially salt water. In this operation, in the context of the process according to the invention, generally the raw water is not heated to a temperature above the boiling point of the raw water used. In order to make the process particularly efficient, preferably waste heat from other processes and/or solar heating is used. In a special embodiment, a raw water reservoir, especially a salt water reservoir, is provided, in which the heat input takes place and which can simultaneously serve as heat store.

In step d), the raw water is fed to an evaporation zone. An evaporation zone, in the context of the present invention, is taken to mean a zone in which water is transferred from the raw water to the carrier gas stream. The water is converted into the gaseous state in this case below its boiling temperature. The evaporation zone can be disposed within a region of a component, within an entire component, or within two or more components. In a preferred embodiment, the evaporation zone is situated in a separate component or within a region of a component. The evaporation zone can be situated in a reactor, for example a tower reactor, a column, a mass transfer apparatus, a saturator, or another suitable device.

According to the invention, the evaporation zone is operated substantially adiabatically. “Adiabatic” is taken to mean heat-insulated in thermodynamics. An adiabatic change of state is a thermodynamic process in which a system is converted from one state to another without exchanging thermal energy with its surroundings. “Operated substantially adiabatically” is therefore taken to mean, in the context of the present invention, that no heat, or only a negligibly small amount of heat, is exchanged between the evaporation zone and the surroundings. Effects such as solar irradiation on the device, heat radiation of the device to the environment, etc., are generally negligible. If the temperature effects and/or the climatic effects of the environment on the evaporation zone are not negligible, the device can be appropriately insulated in the region of the evaporation zone in order to make possible a substantially adiabatic mode of operation. The heat input required for the vaporization process proceeds according to the invention outside the evaporation zone into the raw water.

According to the invention, the carrier gas is transported by means of natural convection through the evaporation zone and thereafter through the heat exchanger.

“Natural convection” here, and hereinafter, is taken to mean the physical effect by which a fluid, in particular a gas, owing to the density difference, is transported from a warm region to a cold region (density gradient). The density difference is maintained by heating or warming in one region and cooling in another region (temperature gradient). Under the influence of gravitation, zones of lower density ascend against the gravitation field within the gas (buoyancy) whereas zones of higher density descend. If heat is supplied in the bottom region, a continuous flow is generated; the gas is heated, expands, and ascends. The resultant differential pressure is termed “driving pressure” or “active pressure”. Natural convection is utilized predominantly in connection with gases, for example carrier gases, and in particular air. A typical example is a flame, such as a candle flame or a lighter flame. Due to the convection of the ascending gas, the combustion air descends according to the arising vacuum. Starting from the flame inner core towards the periphery, a steep temperature gradient is generated, so that the flue gases ascend, suck in and entrain the surrounding air. Above the flame, even though the effect continues, it wears off rapidly since no further temperature gradient is generated. In this way, a natural chimney or a stack, that is without defined boundaries, sucking in air vertically from the bottom and horizontally from all sides and conveying it vertically upward.

If a gas flows over or around a fluid, in addition to heat transfer, mass transfer takes place. If the vapor pressure of the gas is below its saturation vapor pressure, i.e. if the gas is not saturated, part of the fluid diffuses into the gas phase. A difference in temperature is not essential but nevertheless beneficial. Even if the gas has the same temperature as the fluid or higher, the fluid will be cooled on losing evaporation heat. Natural convection can also take place in that the mass transfer causes a change in the density of the gas causing the gas to ascend or descend, even if the temperature difference is too small to cause buoyancy. In this case, mass and heat transfer interfere with one another both following similar rules, what is also known as analogy among heat and mass transfer.

In the process according to the invention the effect of natural convection of the gas owing to the temperature gradient is additionally reinforced by the differing water vapor content in the carrier gas. Since water vapor generally has a lower density than the carrier gas, the moist carrier gas is lighter than the dry carrier gas. The moist carrier gas therefore naturally flows upwards, whereas the dry carrier gas descends. In the process according to the invention, the carrier gas is transported solely by the effects of the density differences. Warm and/or moist air has a lower density than cold and/or dry air. Thereby, a lift is generated for the warm moist air and a reduced pressure is generated which is compensated for by an inflow of cold dry air.

The functioning of stacks in firing technology is based thereon, for example. The stack effect or chimney effect is the movement of air into and out of buildings, chimneys, flue gas stacks, or other containers due to buoyancy. Buoyancy occurs due to a difference in indoor-to-outdoor air density resulting from temperature and moisture differences. The greater the thermal difference and the height of the structure, the greater is the buoyancy force and thus the stack effect. To ascertain a sufficient buoyancy force despite of heat losses at the inner walls, the dimensioning of the chimney has to be considered in terms of height and inner width.

To support the natural convection of the gas stream or in order to make the process still more efficient, residual dehumidification of the carrier gas after it has passed out of the condensation zone or of the countercurrent flow heat exchanger can be provided subsequent to step i).

Advantageously, no mechanical energy for transporting the carrier gas stream need be supplied to the process according to the invention. Optionally, however, an input of mechanical energy can additionally be provided, for example using a fan, for supporting the gas flow, e.g. on startup or in the event of unfavorable climatic conditions.

In step g), the concentrated raw water obtained in step f) is taken off from the evaporation zone. The raw water taken off in step g) is generally warmer than the provided raw water, by a maximum of 25° C., preferably by a maximum of 15° C., and in particular by a maximum of 5° C. Therefore, it can be drained directly into a receiving body of water or a corresponding treatment device. If the concentrated raw water is at least 10° C., preferably at least 20° C., and in particular at least 30° C., warmer than the raw water provided, pre-heating of the provided raw water before entry into the heat exchanger in step b) can be provided using the concentrated raw water from step g). For this purpose, a heat exchanger suitable for raw water streams, especially salt water streams, or any other suitable device, can be used.

In a preferred embodiment of the process according to the invention, the evaporation zone has internals that enlarge the mass transfer area.

Internals which can be used for increasing the mass transfer area are, in principle, all internals that are suitable for use in mass transfer apparatuses, for example for absorption, distillation, drying. These can be both ordered packings and also dumped beds. They can be regularly or irregularly, coated or uncoated. Industrially produced ordered packings or dumped beds of metal, plastic or ceramics, dumped beds of stones or other natural materials, or combinations thereof, can be used. In a suitable embodiment, the internals are made of a biogenic material, in particular of plant origin such as branches, straw, brushwood and the like. Preferably, the internals are water-wettable. Likewise preferably, the internals have a high specific surface area. Equally preferably, the internals have a low pressure drop. Particularly preferably, internals are made of plastic. In a suitable design, plastic fibers are used, for example in the form of a braided fabric, laid fabric, woven fabric, loop-formingly knitted fabric or loop-drawingly knitted fabric. Fabrics which are particularly suitable are loop-drawingly knitted fabrics of water-wettable plastic fibers, since loop-drawingly knitted fabrics not only have a high specific surface area but also a low pressure drop.

The internals can either occupy parts of the cross section or the entire cross section of the evaporation zone perpendicularly to the main direction of flow of the carrier gas stream. In this case they decrease the cross section available for the gas and liquid passage, preferably by 1% to 50%. The selection and dimensioning of suitable internals is known to those skilled in the art. In the case of large cross sections, the most uniform distribution possible of the heated raw water onto the internals enlarging the mass transfer area is of importance.

The internals are preferably selected in such a manner that the mass transfer area is dimensioned to be at least large enough that the evaporation zone corresponds to a mass transfer apparatus having more than one theoretical equilibrium stage.

Using the model of the theoretical equilibrium stage (also called ideal equilibrium stage, theoretical separation plate or ideal separation plate), in process engineering, thermal separation processes, mixing processes of gas and liquid streams, distillations and many other processes are described. The equilibrium stage model can be used not only for describing cocurrent flow apparatuses but also countercurrent flow apparatuses. It characterizes the action of a thermal apparatus by the number of equilibrium stages describing it. This number of equilibrium stages is not a pure apparatus factor but depends, in particular, on the material system, the thermodynamic state, and the mass streams in the apparatus. The theoretical equilibrium stage is characterized in that the mass streams that leave the stage are in thermodynamic equilibrium. This means, for example for an absorber, that the gas and the liquid which leave a stage each have the same temperature and the same pressure. The calculation of such (theoretical) equilibrium stages is familiar to those skilled in the art and can be carried out for example by computer using programs such as ASPEN or Chemasim (simulation software developed by BASF SE).

In a suitable embodiment of the process according to the invention, in step f), the carrier gas and the raw water are brought to mass transfer in the evaporation zone by spraying, injecting, or instilling the raw water into the carrier gas. In the embodiment as a desalination process, in step f), the carrier gas and the salt water are brought to mass transfer in the evaporation zone preferably by injecting or instilling the salt water into the carrier gas.

An enlargement of the mass transfer area can be achieved also by this measure. Internals in the evaporation zone can then be optionally dispensed with. The evaporation zone, however, can additionally have internals in this embodiment also.

If the pure water obtained according to the invention (i.e. in the case of a desalination process, the freshwater) must be desalted as far as possible for further use, for example having a salt content of at most 0.01%, optionally a demister can be provided before entry of the loaded carrier gas into the heat exchanger for condensation in step h).

In a suitable embodiment of the process according to the invention, the carrier gas, after it leaves the heat exchanger (step i)), is passed back into the evaporation zone (step f)). In this embodiment, the carrier gas is conducted in a closed circuit in which the carrier gas circulates between a warm zone having a heat source and a cold zone having a heat sink owing to the difference in density.

In this case, under the influence of gravitation, zones of lower density ascend against the gravitation field within the gas (buoyancy) whereas zones of higher density descend. If heat is supplied in the bottom region, a continuous flow is generated; the gas is heated, expands, and ascends. Reaching the top, it is cooled, contracts, and descends to be heated in the bottom region again.

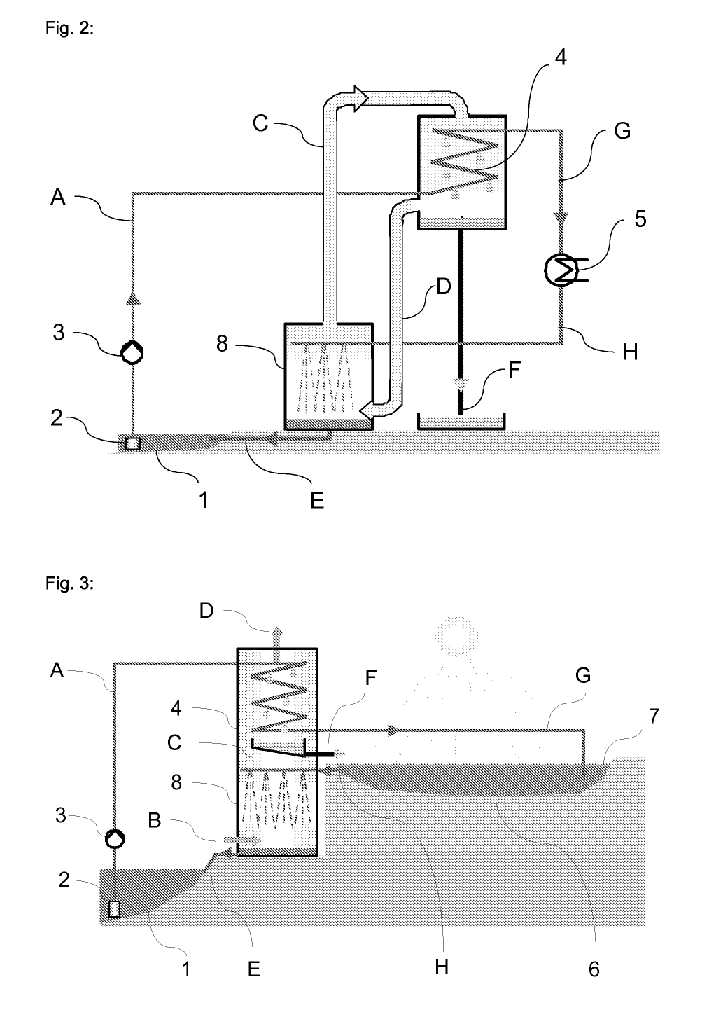

The convection effect can be still enforced, if the descending carrier gas and the ascending carrier gas are spatially separated. A particularly suitable embodiment of the process is shown in FIG. 2. This spatial separation can be put into practice by, for example, heating the carrier gas at the lower end of a first tube and cooling it at the upper end of a second tube. In this case, the tubes can be arranged horizontally and in particular as tube-in-tube.

In a preferred embodiment of the process according to the invention, for the supply of heat in step c), solar heating is utilized.

Solar heating, in the context of the present invention, denotes the conversion of solar energy into thermal energy, i.e. heat for heating the raw water used in the process according to the invention is obtained from the solar irradiation. Both the passive utilization and also the active utilization of solar energy are possible. In the case of passive utilization, the sun heats the raw water directly, such as, for example, in the case of a solar pond. Active utilization occurs when absorber surfaces collect the solar energy and transfer it to a heat store, such as, for example, by means of a solar collector.

A solar collector in the context of the present invention is a thermal solar collector, i.e. a device for collecting the energy present in sunlight. Such a solar collector uses the “trapped” solar energy to heat a transfer medium, also termed a heat carrier. In this case virtually the entire radiation spectrum of sunlight is utilized at relatively high efficiency. A central component of the solar collector is a solar absorber which converts the light energy of the sun into heat and gives it off to a heat carrier or a solar transmitter that allows the light radiation to pass through but not the heat resulting therefrom. Using the heat carrier, the heat is removed and is subsequently used directly or stored.

For supplying heat by means of solar heating, in the context of the present invention, solar absorbers, solar transmitters, heat exchangers, solar collectors, solar ponds and also other devices that are suitable for transferring heat radiation to the raw water provided, especially salt water, can be used, such as, for example, flexible tubes, tubes, etc. and suitable combinations thereof. These devices can be made, for example, of glass, plastic, metal, and/or suitable combinations thereof.

In a preferred embodiment, a salt water reservoir is used. The salt water reservoir can be a natural salt water lake or an artificially constructed pond which can act at the same time as heat store, e.g. for night operation. The salt water provided in this case takes over the function of the heat carrier. The salt water reservoir can be open, partially or entirely covered by a solar transmitter, or can be bridged by a solar transmitter.

The solar transmitter has the task of permitting the irradiation of the sun—even at a low angle of irradiation—as completely as possible into the interior of the collector and as far as possible to prevent the escape of heat in the form of evaporation, convection, and radiation. The solar transmitter is therefore a medium substantially permeable to solar rays. It can comprise, for example, glass, such as, for example, simple glass, which can also have an antireflection coating, or plastic, such as, for example, polyethylene (PE), polypropylene (PP), PE/PP copolymers, PET, polycarbonate or ethylene/propylene-diene monomer-terpolymers (EPDM) or a combination thereof. The solar transmitter can be continuous, such as, for example, a film, a screen, etc., or can comprise a plurality of elements such as, for example, panels etc. It can be structured or planar. The solar transmitter can be transparent, partially transparent, or non-transparent, completely or in regions.

Expediently, the solar transmitter should have an insulating action with respect to heat conduction, and should reflect the heat radiation of the raw water, especially the salt water. Suitable solar transmitters are known to those skilled in the art and are commercially available.

Optionally, the raw water reservoir (especially salt water reservoir) can be insulated from the environment in order to keep heat losses as low as possible. Expediently, the bottom of the reservoir is of dark color, in particular black, the radiation/absorption being as close to a black body as possible. Suitable heat insulation must be taken into account before constructing the raw water reservoir.

The raw water reservoir can expediently combine the functions of a solar collector and a heat store. The water at the bottom is more salty and therefore denser than at the surface. If solar radiation is absorbed in the lower layers, these heat up further, for example up to 85 to 90° C. Owing to the density gradient existing due to the differing salt content, the heated water cannot ascend, convection does not take place, and the heat is stored in the lower water layer. The stored heat can be available for 24 hours a day, with an appropriate design.

In a particularly preferred embodiment of the process according to the invention, a salt water reservoir having a solar transmitter is used and the vapors from the saturator are passed between the surface of the salt water in the salt water reservoir and the solar transmitter before they enter the heat exchanger for condensation. In this embodiment of the process according to the invention, steps c) and f) are in part carried out in parallel in the same device. In this case the salt water reservoir and the gas layer thereabove below the solar transmitter form a part of the evaporation zone.

In an alternative preferred embodiment of the process according to the invention, for the supply of heat in step c), waste heat from other processes is utilized. For this purpose, particularly preferably, a heat exchanger is used in which a suitable heat carrier from another process acts as heating medium which heats further the already preheated salt water. The heat carrier can be, for example, warm wastewater, heat carrier oil, steam such as, for example, saturated steam or superheated steam, or another medium suitable for such an application. The design of such heat carriers is familiar to those skilled in the art.

In principle it is also possible to combine waste heat from other processes and solar heating for supplying heat in step c), and so both forms of energy supply are employed simultaneously and/or alternately.

In a further preferred embodiment of the process according to the invention, the carrier gas is brought into contact with the raw water, especially the salt water, in step f) in two or more than two evaporation zones. In this case the carrier gas and the raw water are brought into contact in countercurrent flow in at least one evaporation zone. In a special embodiment, the carrier gas is saturated in two stages: in a first stage the carrier gas and the raw water are brought into contact in countercurrent flow in the first evaporation zone; and in a second stage the vapors from the saturator are conducted between the surface of the raw water in the raw water reservoir and the solar transmitter before the vapors are passed into the heat exchanger for condensation. In this embodiment, the raw water reservoir and the gas layer thereabove below the solar transmitter form the second evaporation zone.

In a suitable embodiment of the process according to the invention, the pure water obtained in step k) (freshwater) is subjected to one or more treatment steps in order to obtain drinking water.

Drinking water is freshwater having a high degree of purity such that it is suitable for human consumption, in particular for drinking and for food preparation. Drinking water must not contain pathogenic microorganisms and should have a minimum concentration of minerals. The water treatment depends on the quality of the raw water, in the present case of the freshwater obtained after the process according to the invention. The treatment processes depend on the substances present in the raw water or freshwater which are to be removed and on the substances lacking in the raw water or freshwater which are to be added. The customary chemical and/or physical treatment methods suitable for obtaining drinking water are known to those skilled in the art.

The present invention further relates to an apparatus for continuously obtaining pure water from raw water comprising
a device for feeding the raw water into the apparatus;
a heat exchanger in which a water vapor-comprising carrier gas and the raw water are conducted in countercurrent flow, wherein at least some of the water vapor present in the carrier gas condenses out and the salt water raw water is heated;
a device for heat supply in which the raw water that is already heated in the heat exchanger is further heated;
an evaporation zone in which the raw water from the device for heat supply and the carrier gas are brought into contact, wherein the carrier gas is enriched with water vapor and is provided as water vapor-comprising carrier gas for introduction into the heat exchanger;
an outlet device for the concentrated raw water from the evaporation zone;
a take-off device for the condensed pure water from the heat exchanger.

According to the invention, the carrier gas is transported by means of natural convection through the evaporation zone and thereafter through the condensation zone.

The present invention relates especially to an apparatus for continuously obtaining freshwater from salt water comprising the following components:
a device for feeding the salt water into the apparatus,
a heat exchanger in which a water vapor-comprising carrier gas and the salt water are conducted in countercurrent flow, wherein at least some of the water vapor present in the carrier gas condenses out and the salt water is heated,
a device for heat supply in which the salt water that is already heated in the heat exchanger is further heated,
an evaporation zone in which the salt water from the device for heat supply and the carrier gas are brought into contact, wherein the carrier gas is enriched with water vapor and is provided as water vapor-comprising carrier gas for introduction into the heat exchanger,
an outlet device for the concentrated salt water from the evaporation zone, and
a take-off device for the condensed freshwater from the heat exchanger.

In this embodiment of the novel device, too, the carrier gas is transported by means of natural convection through the evaporation zone and thereafter through the condensation zone.

To ensure natural convection of the carrier gas, the gas loading factor F is preferably in the range of from 0.1 to 10 Pa^{1/2}. This corresponds to a Reynolds number in the range 10≦Re≦10⁹. Even more preferably, the gas loading factor F is in the range of from 0.5 to 5 Pa^{1/2}. This corresponds to a Reynolds number in the range 10³≦Re≦10⁸. In particular, the gas loading factor F is in the range of from 1 to 3 Pa^{1/2}. This corresponds to a Reynolds number in the range 5*10⁴≦Re≦5*10⁶.

The gas loading factor F or F-factor is a characteristic factor expedient for the dimensioning of mass transfer units, such as reactors, columns, trays, pipes and the like. F is defined as in formula (I):

F=w_{G}*(ρ_{G})^{1/2} (I)

with

w_{G}=V_{G}/A (II)

in which

F is the gas loading factor in [Pa^{1/2}]

w_{G} is the medium velocity of the loaded carrier gas in [m/s]

ρ_{G} is the density of the loaded carrier gas in [kg/m³]

V_{G} is the volume flow of the loaded carrier gas in [m³/s]

A is the cross section surface of the evaporation zone in [m²].

According to formula (III), the Re number can also be calculated:

Re=(w_{G}*ρ_{G}*D)/η_{G} (III)

in which

Re is the Reynolds number in [−]

w_{G} is the medium velocity of the loaded carrier gas in [m/s]

ρ_{G} is the median density of the loaded carrier gas in [kg/m³]

η_{G} is the median viscosity of the loaded carrier gas in [Pa*s]

D is the diameter of the evaporation zone in [m].

Further explanation of the F-factor can be found e.g. in Klaus Sattler, “Thermische Trennverfahren”, VCH Weinheim, 1995, pages 20 seq. The dimensioning of mass transfer units is generally known to the person skilled in the art.

Hereinafter, raw water designates especially salt water and pure water designates especially freshwater.

The device for feeding the raw water into the apparatus comprises a feed line from a preexisting natural or artificially constructed body of water and a suitable transport means, for example a pump or a transport screw such as, e.g., an Archimedean screw. The water body can be flowing water, e.g. a river or canal, or static water, e.g. a lake or a collecting tank. It can be an above-ground water body, such as an inland water body or a sea, or else a subterranean water body.

The feed line is essentially a pipe. Depending on the type of the pump, further fittings, e.g. shut-off valves or throttling units, need to be provided on the feed line. In addition, a mechanical prepurification stage such as, for example, a strainer, a filter, a membrane, a screen, a hydrocyclone, another mechanical separator for removing solids, or a combination thereof is generally required. Optionally, chemical and/or biological prepurification can also be provided. In particular, treatment with active ingredients can be provided that reduce biological growth, for example of algae.

Since the pressure drops that must be overcome are small and no coarse solids are present in the raw water provided, in principle all pump types come into consideration for transporting the raw water. Typical structures are displacement pumps and centrifugal pumps in anticorrosion designs. The pump used for transporting the raw water stream can be driven by an electric motor or by an internal combustion engine, e.g. a gas or diesel engine. The electric motor, in a preferred embodiment, can be driven by solar energy, e.g. from locally installed solar cells. A suitable pump drive is also a Stirling engine, which is supplied with solar energy by, for example, a parabolic mirror. The raw water pump, taking into account the corrosive medium, can be selected according to economic and/or ecological aspects. The selection and layout of suitable raw water pumps is known to those skilled in the art.

In a suitable embodiment of the apparatus according to the invention, the waste heat of the pump is used in order to heat the raw water that is provided. The point at which the waste heat of the pump is introduced depends substantially on the location of the pump. In principle it can be introduced at any desired point upstream of the entry into the evaporation zone of the raw water that is provided.

The pipes, i.e. tubes and fittings, can comprise a readily available material that is resistant to raw water, such as, for example, steel, corrosion-resistant metal alloys, coated materials, plastics, or combinations thereof. Preferably, the tubes are made of plastic.

The heat exchanger used is a countercurrent flow heat exchanger suitable for condensing water from a carrier gas stream. In the case of the media used, generally the gas volume flow rate through the heat exchanger will be greater than the liquid volume flow rate. In addition it is generally necessary to increase the area for heat transfer to the gas. In a suitable embodiment, therefore, the raw water is conducted in tubes. In an equally suitable embodiment, the exchange surface is provided on the gas side with structures that increase the surface areas such as, e.g., cooling fins or sheets. The heat exchanger is preferably a tube-bundle, plate, or micro heat exchanger. The exchange surface facing the gas can comprise inexpensive materials, e.g. can be made of tin plate or materials such as are used for commercially available air coolers. For the zone of the heat exchanger that comes into contact with the raw water, preferably inexpensive metals are used which can be appropriately coated, for example with a corrosion-resistant plastic. The coating is expediently selected in such a manner that it has a lowest possible heat resistance and, in addition, is resistant to deposits, scaling and fouling. Alternatively, it is also possible to use a non-corrosion-resistant, but cheap, condenser as a heat exchanger which will then be replaced in relatively short intervals. The selection, dimensioning, and layout of suitable heat exchangers is known to those skilled in the art.

In a preferred embodiment of the apparatus according to the invention, the device for heat supply is a heat exchanger. In the heat exchanger, the raw water that is to be heated is heated by means of a heating medium. The heating medium can be heated by means of conventional methods, preferably by means of solar energy, or utilizing waste heat from other processes. Particularly preferably, waste heat from other processes is utilized. The heat carrier can be, for example, warm wastewater, heat carrier oil, steam such as, for example, saturated steam or superheated steam, or another medium suitable for such an application. The layout of such heat exchangers is familiar to those skilled in the art.

In an alternative preferred embodiment of the apparatus according to the invention, the device for heat supply is a raw water reservoir. The raw water reservoir can be a natural raw water lake or an artificially constructed pond which can act at the same time as heat store, e.g. for night operation. The raw water provided takes over the function of the heat carrier. The raw water reservoir can be open, partially or completely covered by a covering, or be bridged by a covering.

Preferably, the raw water reservoir is provided with a covering permeable to sun rays, which covering can at the same time act as a heat insulator (=solar transmitter). For example, the covering can be made of glass, such as, e.g., simple glass, which can also have an antireflection treatment, or plastic, such as, for example, polyethylene (PE), polypropylene (PP), PE/PP copolymers, PET, polycarbonate or ethylene/propylene-diene monomer-terpolymers (EPDM), or a combination thereof. The covering can be continuous such as, for example, a film, a screen etc. or comprise a plurality of elements such as, for example, panels etc. It can be structured or planar. The covering can be transparent, partially transparent, or non-transparent, completely or in regions. Suitable coverings are known to those skilled in the art and are commercially available.

Particularly preferably, the covering acts as a solar transmitter, in such a manner that the device for heat supply can utilize solar heating.

Optionally, the raw water reservoir can be insulated from the environment in order to keep heat losses as low as possible. Suitable heat insulation must be taken into account before laying out the raw water reservoir.

In a suitable embodiment, a gas layer is situated between the raw water surface of the raw water reservoir and the covering.

In a special embodiment of the apparatus according to the invention, the vapors from the saturator are conducted between the surface of the raw water in the raw water reservoir and the solar transmitter, before the vapors enter the heat exchanger for condensation. In this embodiment, the raw water reservoir and the solar transmitter form an additional evaporation zone.

In principle it is also possible to combine a raw water reservoir and a heat exchanger, and so two devices for heat supply are used simultaneously and/or alternately.

In the evaporation zone, water transfers from the raw water into the carrier gas stream below the boiling temperature thereof. The evaporation zone can be arranged within a region of one component, within an entire component or within two or more components. In a preferred embodiment, the evaporation zone is situated in a separate component or within a region of one component. The evaporation zone can be situated in a column, for example a randomly-packed column, a spraying tower, a tube arranged vertically or at an incline or horizontally that has a round or angular cross section, or another suitable device.

In a particularly preferred embodiment of the apparatus according to the invention, the evaporation zone is constructed as a saturator with internals. A saturator, in the context of the present invention, is taken to mean an apparatus that enriches one fluid stream with a second fluid up to saturation. Fluids, in the context of the present application, are taken to mean liquid or gaseous media or mixtures thereof. Under the respective operating conditions, saturation need not necessarily be achieved. In the present case, a (carrier) gas stream is enriched with water vapor in the saturator.

By means of internals, the mass transfer area may be enlarged. These internals can be either ordered packings or else dumped beds. They can be regular or irregular, coated or uncoated. Industrially manufactured ordered packings or dumped beds made of metal, plastic or ceramics, dumped beds made of stones or other natural materials or combinations thereof can be used. Preferably, the internals are water-wettable. Equally preferably, the internals have a high specific surface area. Equally preferably, the internals have a low pressure drop. Particularly preferably, internals are made of plastic. In a suitable embodiment, fibers made of plastic are used, for example in the form of a braided fabric, laid fabric, woven fabric, loop-formingly knitted fabric or loop-drawingly knitted fabric. Those which are particularly suitable are loop-drawingly knitted fabrics made of water-wettable plastics fibers, since loop-drawingly knitted fabrics not only have a high specific surface area but also a low pressure drop.

The internals can occupy either parts of the cross section or preferably the entire cross section of the evaporation zone perpendicularly to the main direction of flow of the carrier gas stream. In this case they decrease the cross section available for gas and liquid throughflow preferably by 50% to 1%, particularly preferably 10% to 1%. The selection and dimensioning of suitable internals are known to those skilled in the art.

In another preferred embodiment of the apparatus according to the invention, the evaporation zone is arranged in an annular body which floats on the water body, for example the sea. Not only the base but also the cross section of the annular body can be polygonal, ellipsoidal, or circular. The preferred shape for the base and/or the cross section is the circular shape. Such a tire-type or doughnut-shaped body will be termed hereinafter torus.

The horizontal (circular) sectional area of the torus is sealed in the lower region from the water body by a base, in such a manner that the torus and the base enclose a raw water reservoir. In the annular space (vertical (circular) cross section) of the torus, the raw water and the carrier gas are conducted in countercurrent flow. In a preferred embodiment, the heat exchanger in which the condensation takes place is arranged in a vertical cylindrical housing, hereinafter also termed tower, which is mechanically stabilized by the torus. In a particularly suitable embodiment, the tower and the torus are arranged coaxially. In a special embodiment, tower and torus are arranged concentrically. The area between tower and torus is entirely covered by a covering (solar transmitter) or bridged with a covering. That already stated hereinbefore applies to the covering. Between the raw water surface of the raw water reservoir and the covering, the presaturated carrier gas from the torus can pass over the raw water reservoir, in this case be additionally enriched with water vapor, and thus be conducted into the tower. This feed can take place, in particular, in a spiral shape.

The torus is fabricated from a material which is corrosion-resistant with respect to raw water and ensures the required buoyancy for floating the arrangement of torus, tower, and base on the raw water provided. Preferably, the torus is made of plastic, such as, for example, PU, PVC, polyester, polyamide or glass fiber reinforced plastic (GRP), particularly preferably glass fiber reinforced plastic (GRP). Particularly preferably at least the external walls of the arrangement according to the invention comprise plastic, such as, for example, PU, PVC, polyester, polyamide or GRP, particularly preferably GRP.

In the apparatus according to the invention, the carrier gas is transported by means of natural convection through the evaporation zone and thereafter through the condensation zone.

The natural convection utilizes the physical effect that a gas or carrier gas is transported from a warm region to a cold region owing to the density difference. The density difference is maintained by heating or warming in one region and cooling in another region. According to the invention, the effect of natural convection is reinforced by the differing content of water vapor in the carrier gas owing to a temperature gradient. Since water vapor has a lower density than the carrier gas (except for methane), the moist carrier gas is lighter than the dry carrier gas. The moist carrier gas therefore naturally flows upwards in contrast the dry carrier gas descends. The carrier gas is transported through the apparatus according to the invention solely by the effects of the density differences. Thus no mechanical energy need be supplied for transporting the carrier gas stream. However, optionally, a fan can additionally be provided for supporting the gas flow, e.g. on startup or in adverse climatic conditions.

To ensure natural convection of the carrier gas, the gas loading factor F is preferably in the range of from 0.1 to 10 Pa^{1/2}, corresponding to 10≦Re≦10⁹. Even more preferably, the gas loading factor F is in the range of from 0.5 to 5 Pa^{1/2}, corresponding to 10³≦Re≦10⁸. In particular, the gas loading factor F is in the range of from 1 to 3 Pa^{1/2}, corresponding to 5*10⁴≦Re≦5*10⁶.

The gas loading factor F has been explained in detail above, to which reference is made here.

The carrier gas used according to the invention can be a substance and mixture of substances gaseous under the operating conditions. These include, e.g., air, carbon dioxide and nitrogen, and also mixtures thereof. In a preferred embodiment of the apparatus according to the invention, the carrier gas is air. The water content of the carrier gas provided preferably does not exceed 70% by volume. It is, for example, in the range from 10 to 45% by volume, preferably in the range from 20 to 35% by volume.

A suitable embodiment of the apparatus according to the invention comprises a post-condenser for residual dehumidification of the carrier gas subsequent to the condensation zone. In order to support the natural convection of the gas stream and/or to make the process still more efficient, residual dehumidification of the carrier gas can be provided after it is passed out of the condensation zone or out of the countercurrent flow heat exchanger.

An equally suitable embodiment of the apparatus according to the invention comprises a further heat exchanger which preheats the raw water that is fed into the apparatus by further cooling of the raw water taken off from the evaporation zone. This preheating of the raw water provided can alternatively also proceed by partial or complete mixing with concentrated raw water that is taken off from the process.

If the raw water taken off from the evaporation zone is warmer than the raw water that is provided by at least 10° C., preferably by at least 20° C., and in particular by at least 30° C., the raw water that is fed into the apparatus can, before entry into the heat exchanger for condensation, be preheated with the raw water that is taken off from the evaporation zone. For this purpose a further heat exchanger suitable for raw water or another suitable device can be used. The selection and dimensioning of such devices, and in particular heat exchangers, are familiar to those skilled in the art.

Particularly preferably, the process according to the invention is carried out in an apparatus according to the invention.

The present invention also relates to the use of pure water obtainable by the process according to the invention and/or in an apparatus according to the invention as drinking water, service water, or as desalted process water.

Pure water obtainable according to the invention can be further used either as service water or else as drinking water. Service water serves a specific technical, commercial, agricultural, or domestic use. In contrast to drinking water, it is not provided for human consumption, but should, however, correspond to a certain minimum hygiene level. Drinking water, in contrast, must meet high quality requirements in order that it is suitable for human consumption. The treatment processes for drinking water or service water depend on the substances that are present in the raw water or pure water and which are to be removed and on the substances lacking in the raw water or pure water which are to be added. The customary chemical and/or physical treatment methods suitable for obtaining drinking water and service water are known to those skilled in the art.

Process water is a type of service water necessary for operating or maintaining an industrial process. The quality requirements are frequently already met by the pure water obtained according to the invention, and so further treatment for use as desalinated process water can be superfluous.

If the pure water obtained according to the invention needs to be completely demineralized for further use, for example as process water, for example having an electric conductivity less than 5 μS at 25° C., optionally a demister can be provided before entry of the loaded carrier gas into the heat exchanger for condensation in step h).

The present invention offers important advantages over the prior art:

Since the process according to the invention uses a carrier gas, in contrast to the MEV or MSF process, a multistage countercurrent flow process can be implemented in a single apparatus. Moreover, in contrast to the MEV or MSF process, supersaturation cannot occur at any point of the heat exchanger, so encrustations are avoided which can constrict the heat exchanger output or lead to a failure. Furthermore, the not inconsiderable transport expenditure for the carrier gas as is necessary, for example, for the process described in DE 19620214, DE 102005046643, and DE 102004005689 as well as for the dewvaporation process, is avoided, because the process according to the invention uses natural convection to transport the carrier gas. In addition, the process is extensively insensitive to fouling and scaling. Since virtually all internals that come into contact with brine, such as internals in the saturator or covering of the raw water reservoir, are insensitive to fouling and in addition are simple to clean, the process does not require complex and expensive brine pretreatment such as, e.g., the membrane processes, the Memstill process, or else the MEV or MSF processes. According to the invention, simple components made of inexpensive materials are used. In addition, the process is not sensitive to faults in operation and runs very largely independently, and so it requires scarcely any operating personnel. It is therefore also suitable for use in remote areas or in developing countries.

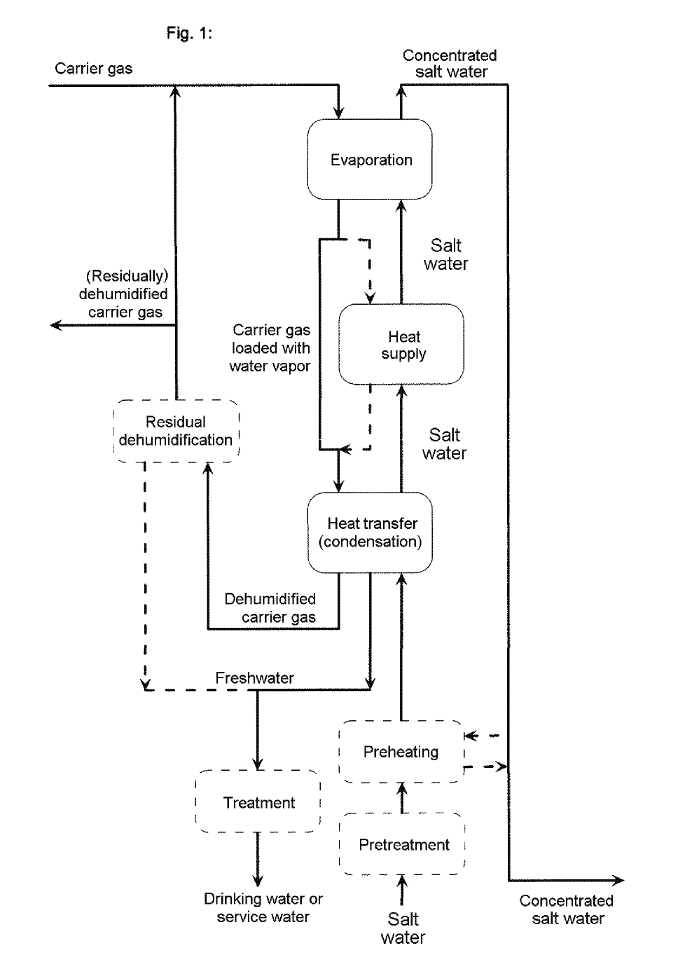

Hereinafter, the process according to the invention and the apparatus according to the invention will be described in more detail with reference to FIGS. 1 to 6.

FIG. 1 shows a flowchart of the process according to the invention.

FIG. 2 shows schematically an embodiment in which the carrier gas is circulated and which uses auxiliary power supply.

FIG. 3 shows schematically an embodiment having a raw water tank, wherein solar heating is used for the heat supply.

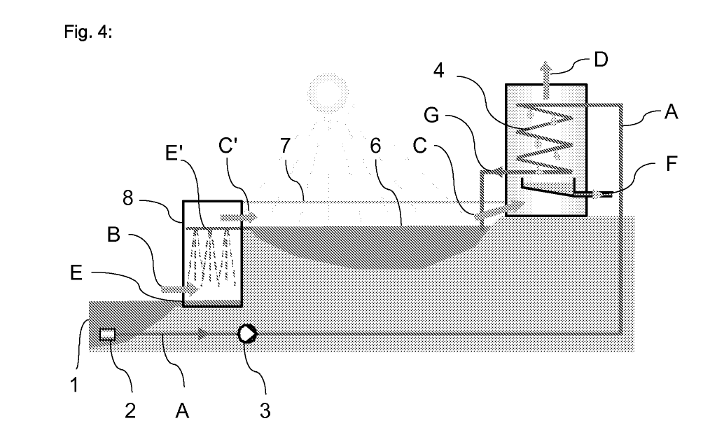

FIG. 4 shows schematically an embodiment having a two-stage saturation of the carrier gas stream.

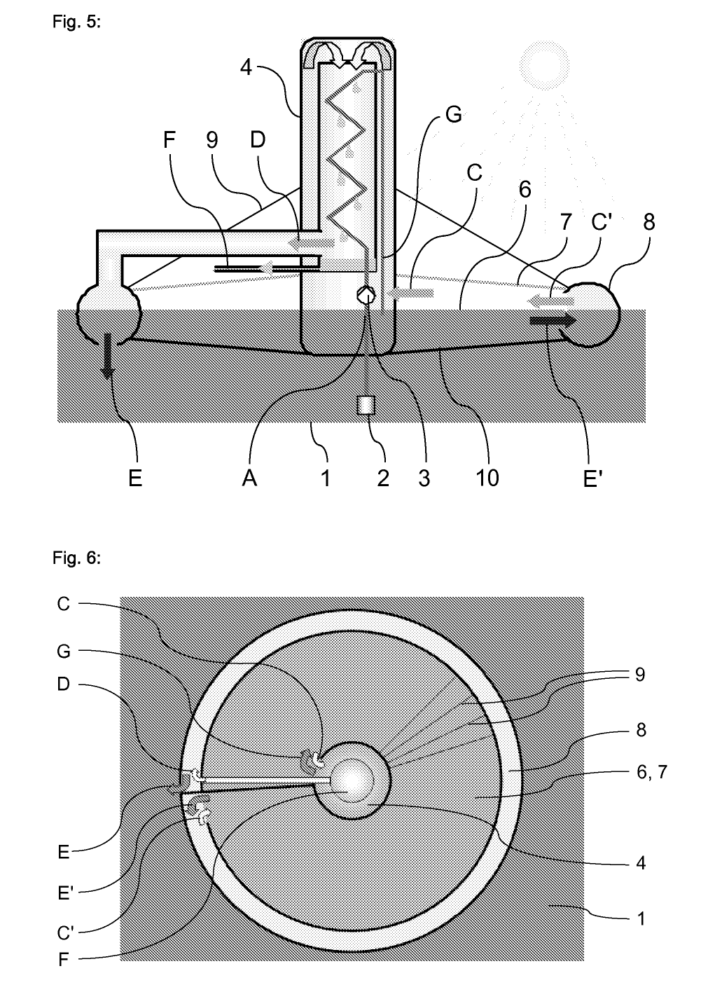

FIG. 5 shows schematically an embodiment in the form of an island having a tower and torus.

FIG. 6 shows a plan view of the embodiment shown in FIG. 5.

FIG. 1 shows a flowchart of the process according to the invention. This shows not only the process steps that are essential to the invention but also optional process steps (dashed lines). Further process steps can result from special embodiments, for example by the multistage design of a process step.

The process according to the invention operates substantially with two material streams: one raw water stream and one carrier gas stream. The carrier gas that is loaded with water vapor is also hereinafter termed vapors. The carrier gas and the raw water are in principle conducted countercurrently.

As may be seen from the flowchart in FIG. 1, the process according to the invention substantially comprises the three process steps heat transfer or condensation, heat supply and evaporation.

The raw water provided, e.g. seawater, is optionally pretreated, for example conducted through a filter and/or conditioned by adding suitable active ingredients against biological deposits. The raw water can also—alternatively or subsequently—be subjected to a preheating.

The raw water is fed to a heat transfer (condensation). The raw water in this step is conducted against the carrier gas loaded with water vapor (that is to say countercurrently), wherein the carrier gas is cooled. During the cooling, water vapor condenses out of the loaded carrier gas. The condensate is taken off as pure water. The pure water obtained is principally demineralized water. However, minimum amounts of salt can be present, which salt originates from raw water droplets entrained by the vapors. Depending on the application and requirements, it is subjected to a treatment before use as drinking water or process water.

By means of the heat transfer, the raw water is heated not only by the heat given off by the carrier gas, but also by the heat of condensation of the pure water. By means of the countercurrent flow passage, a maximum of energy stored in the carrier gas can be released to the raw water. Advantageously, backmixing of the raw water, and especially the carrier gas, is as low as possible, and so the effect of a multistage structure is obtained.

The raw water that is thus preheated virtually to the temperature of the carrier gas is subsequently heated further in the heat supply process stage. The heat can be supplied, for example, via a conventional solar collector, in a raw water reservoir covered by a solar transmitter, or by means of a heat exchanger, by which, for example, waste heat is supplied from another process. The raw water that is thus heated is then fed to an evaporation. In this step it flows countercurrently to the ascending carrier gas into a bottom phase. In this case the raw water gives off heat and water vapor to the ascending carrier gas stream. The cooled raw water is taken off in the bottom phase and passed, e.g., back into the sea. The raw water that is taken off can optionally also completely or partially be utilized for a first preheating of the raw water provided. This preheating of the raw water provided can proceed using concentrated raw water taken off from the process in a heat exchanger or by partial or complete mixing of the two raw water streams, or preferably in a heat exchanger.

The carrier gas passes through the process according to the invention countercurrently to the raw water. Non-loaded carrier gas is subjected to a first process step, evaporation. There, the still non-loaded carrier gas is brought into contact with the heated raw water countercurrently. The carrier gas takes up water vapor from the raw water in this operation. By temperature elevation of the carrier gas along the countercurrent flow, the water absorption capacity of the carrier gas is increased.

The temperature elevation and the enrichment with water vapor generally lead to a reduction of the gas density. The carrier gas loaded with water vapor ascends thereby. This effect of natural convection is expressed the more greatly, the hotter and more greatly enriched with water vapor the vapors are and the greater the difference in height between condensation region and evaporation zone. Therefore, the heat losses of the ascending vapors from the evaporation zone to the heat exchange or to the condensation region should be kept as low as possible, e.g. by suitable insulation.

Alternatively, the carrier gas that is loaded with water vapor can be further heated and saturated via the heat supply upstream of the heat exchanger or condensation.

In the heat exchanger or in the condensation region, the vapors are cooled. During the cooling, water vapor condenses out of the vapors. If the resultant pure water needs to be completely demineralized for further use, optionally a demister can be provided upstream of the entry of the loaded carrier gas into the heat exchanger. The dehumidified carrier gas is taken off and can optionally be subjected to residual dehumidification. The (residually) dehumidified carrier gas can either be passed out or conducted back into the process.

The process, apart from the pressure drop due to the structure of the apparatus, is operated at a pressure stage and at temperatures below the boiling temperature of the raw water. The process according to the invention preferably does not require any mechanical energy for transporting the gas stream. The carrier gas is transported through the process stages by means of natural convection. This can involve a single passage of the carrier gas, or a carrier gas circuit.Mechanical energy is only required for transporting the raw water through the process stages.

The process requires, on the basis of the amount of pure water obtained, less energy than a single-stage evaporation, owing to the countercurrent flow passage. The energy required for enrichment or saturation of the gas stream is largely recovered again in the condensation.

Suitable and preferred embodiments of apparatus according to the invention are shown in FIGS. 2 to 6. The embodiments shown are not intended to restrict the invention thereto, but to illustrate it. In FIGS. 2 to 6, the following reference signs are used:

A raw water provided

B carrier gas provided

C, C′ carrier gas enriched with water vapor

D dehumidified carrier gas

E, E′ concentrated raw water

F pure water

G pre-heated raw water

H heated raw water

1 water body or sea

2 raw water takeoff

3 raw water pump

4 countercurrent flow heat exchanger (condenser)

5 heat exchanger for heat supply

6 raw water reservoir

7 solar transmitter

8 evaporation zone or saturator

9 tension cables

10 base

The streams C′ and E′ labeled with a prime sign each come from the first stage of a two-stage evaporation or saturation.

FIG. 2 schematically shows a preferred embodiment in which the carrier gas is circulated.

In the embodiment shown in FIG. 2, raw water is taken off via a raw water takeoff 2 from the sea 1. The raw water A provided is fed to a countercurrent flow heat exchanger 4, hereinafter also called condenser 4, by means of a pump 3. The raw water A is passed in tubes or a tube coil through the condenser 4. The main direction of flow of the raw water in this case is from bottom to top. In the upper region of the condenser 4, the pre-heated raw water G is taken off. It is then heated further in a heat exchanger for heat supply 5. From there, the heated raw water H passes into the evaporation zone 8, hereinafter also called saturator 8. In the saturator 8, the raw water is sprayed from the top into the carrier gas D that flows in from the bottom. The saturator 8 can also further comprise internals which enlarge the mass transfer area. The carrier gas, in the saturator 8, takes up water in the form of water vapor from the heated raw water H provided. The raw water is concentrated thereby and the carrier gas enriched with water vapor. In the bottom phase of the saturator 8 the concentrated raw water E is taken off and passed back into the sea 1. The carrier gas C enriched with water vapor leaves the saturator 8 overhead. From there it is conducted into the upper region of the condenser 4. The carrier gas C enriched with water vapor flows through the condenser 4 against the main direction of flow of the raw water A provided, that is to say essentially from top to bottom. On flowing through the condenser 4, a fraction as large as possible of the water vapor is condensed out of the carrier gas. The condensed water is collected at the base of the condenser 4 and is taken off as pure water F. The carrier gas D that is dehumidified in the condenser 4 is passed out in the lower region of the condenser 4 and returned to the lower region of the saturator 8.

In this manner a circuit of the carrier gas is effected. Depending on the structure and gas-tightness of the apparatus, an additional infeed of dry carrier gas upstream of the entry of the carrier gas into the saturator 8 is provided.

FIG. 3 shows schematically one embodiment having a raw water tank, wherein solar heating is utilized for the heat supply.

As shown in FIG. 3, raw water is taken off from the sea 1 via a raw water takeoff 2. The raw water A provided is fed to a condenser 4 by means of a pump 3. The raw water A is conducted in tubes or a tube coil through the condenser 4. The main direction of flow of the raw water in this case is from top to bottom. In the lower region of the condenser 4, the pre-heated raw water G is taken off. The preheated raw water passes out of the condenser 4 into a raw water reservoir 6 in which it is heated further. The raw water reservoir 6 uses solar heating by means of a solar transmitter 7 for heating the raw water. The heated raw water H passes out of the raw water reservoir 6 into the saturator 8. In the saturator 8, the heated raw water H is sprayed from the top into the carrier gas B provided which flows into the saturator 8 from the bottom. The saturator 8 can also further comprise internals which enlarge the mass transfer area. The carrier gas B provided, in the saturator 8, takes up water in the form of water vapor from the raw water. This concentrates the raw water and enriches the carrier gas with water vapor. In the bottom phase of the saturator 8, the concentrated raw water E is taken off and passed back into the sea 1. The carrier gas C enriched with water vapor leaves the saturator 8 overhead. From there it passes into the lower region of the condenser 4. The carrier gas C enriched with water vapor flows through the condenser 4 against the main direction of flow of the raw water A provided, that is to say essentially from bottom to top. On passing through the condenser 4, a fraction as large as possible of the water vapor is condensed out of the carrier gas. The condensed water is collected at the base of the condenser 4 and taken off as pure water F. The carrier gas D dehumidified in the condenser 4 is discharged overhead from the condenser 4 into the environment.

The saturator 8, in a particularly preferred embodiment, is arranged in the lower region of a tower. In the upper region of the tower there is situated the condenser 4. This structure reduces the path which the carrier gas covers through the apparatus according to the invention to a minimum. The effect of the natural convection is utilized optimally.

FIG. 4 shows schematically one embodiment having a two-stage saturation of the carrier gas stream.

As shown in FIG. 4, raw water is taken off from the sea 1 via a raw water takeoff 2. The raw water A provided is fed to a condenser 4 by means of a pump 3. The raw water A is passed in tubes or a tube coil through the condenser 4. The main direction of flow of the raw water in this case is from top to bottom. In the lower region of the condenser 4, the pre-heated raw water G is taken off. The pre-heated raw water G passes out of the condenser 4 into a raw water reservoir 6 in which it is further heated. The raw water reservoir 6 utilizes solar heating for heating the raw water by means of a solar transmitter 7. Between the surface of the raw water in the raw water reservoir 6 and the solar transmitter 7, a carrier gas C′ already partially saturated with water vapor in a first stage is passed. The carrier gas C′ that is partially saturated with water vapor takes up further water in the course of this in the form of water vapor from the raw water. The heated and already slightly concentrated heated raw water E′ is passed out of the raw water reservoir 6 into the saturator 8. In the saturator 8 the raw water E′ is sprayed from the top into the carrier gas B provided that flows from the bottom into the saturator 8. The saturator 8 can also further comprise internals which enlarge the mass transfer area. The carrier gas B provided takes up water in the form of water vapor from the raw water E′ in the saturator 8. In the bottom phase of the saturator 8, the further concentrated raw water E is taken off and passed back into the sea 1. The carrier gas C′ enriched with water vapor leaves the saturator 8 overhead and is passed over the surface of the raw water in the raw water reservoir 6. In the course of this it becomes further enriched with water vapor. Then, the carrier gas C that is enriched with water vapor is passed into the lower region of the condenser 4. The carrier gas C enriched with water vapor flows through the condenser 4 against the main direction of flow of the raw water A provided, that is to say essentially from bottom to top. On flowing through the condenser 4 a fraction as large as possible of the water vapor is condensed out of the carrier gas. The condensed water is collected at the base of the condenser 4 and taken off as pure water F. The carrier gas D that is dehumidified in the condenser 4 is discharged overhead into the environment from the condenser 4.

In this embodiment, the carrier gas stream is enriched with water vapor in two stages. In the first stage the carrier gas is passed in one saturator in countercurrent flow to the raw water. In the second stage solar heating is used not only for heating the raw water but also the carrier gas. Water can thereby transfer to an increased extent from the raw water in the form of water vapor into the likewise heated carrier gas. In this embodiment, solar heating is utilized particularly efficiently.

FIG. 5 shows schematically one embodiment according to the invention in the form of an island having a tower (4) and a torus (8). FIG. 6 shows a plan view of the embodiment shown in FIG. 5 which illustrates, in particular, the flow passage of raw water and carrier gas.

The island shown in FIG. 5 floats on the raw water provided or on the sea 1. In the embodiment shown, a countercurrent flow heat exchanger for condensation, in short condenser 4, is arranged in a vertical tower. The tower is essentially a cylindrical housing which is arranged within the torus. In the torus is situated the countercurrent flow evaporation zone 8 according to the invention. The torus is an annular body having an elliptical, in particular circular, cross section. Tower and torus are preferably arranged coaxially. The horizontal (circular) sectional area of the torus is sealed in the lower region from the sea with a base 10 (e.g. an insulating film) in such a manner that the torus and the base enclose a raw water reservoir 6. In the embodiment shown here, the area between tower and torus, that is to say the raw water reservoir 6, is completely bridged by a covering. The covering substantially comprises a solar transmitter 7. Raw water reservoir 6 and solar transmitter 7 form a second evaporation zone. The arrangement is organized in such a manner that the buoyancy necessary for floating on the seawater is ensured.

In the embodiment shown in FIG. 5, raw water is taken off from the sea 1 via a raw water takeoff 2 which is situated beneath the apparatus. Via a pump 3, the raw water A provided is fed to the condenser 4. The raw water A is passed in tubes or a tube coil through the condenser 4. The main direction of flow of the raw water in this case is from bottom to top. In the upper region of the condensation zone, the pre-heated raw water G is taken off. From the top of the condenser 4, the pre-heated raw water G is passed downwards outside the condensation zone and into the raw water reservoir 6. In the raw water reservoir 6, the raw water is further heated by means of the solar transmitter 7. Between the surface of the raw water in the raw water reservoir 6 and the solar transmitter 7 is passed a carrier gas C′ that is already partially saturated with water vapor in a first stage. The carrier gas C′ partially saturated with water vapor takes up in the course of this further water from the raw water in the form of water vapor.

The passage of the raw water and carrier gas streams may also be followed further hereinafter readily with reference to FIG. 6. From the raw water reservoir 6, the heated and already slightly concentrated raw water E′ is passed into the evaporation zone 8 in the interior of the torus. In the evaporation zone 8, the carrier gas D is conducted over the surface of the raw water E′ in countercurrent. The carrier gas D in this case takes up water in the form of water vapor from the raw water E′. From the evaporation zone 8, the further concentrated raw water E is discharged directly into the sea 1. The position at which the concentrated raw water E is passed into the sea 1 is expediently arranged to be sufficiently distant from the raw water takeoff 2, for example corresponding to the radius of the entire arrangement according to the invention. The carrier gas C′ virtually saturated with water vapor leaves the evaporation zone 8 and is passed over the surface of the raw water in the raw water reservoir 6. In the course of this the carrier gas is further enriched with water vapor. The carrier gas C that is further enriched with water vapor is passed into the lower region of the tower. It is passed on the outside past the condensation zone to the upper region of the condenser 4. The feed can proceed, for example, directly and substantially vertically upwards between the outside of the condensation zone and the inner wall of the tower or spirally from bottom to top around the cylindrically arranged condensation zone. The carrier gas C enriched with water vapor is fed from the top into the condenser 4 and flows through it against the main direction of flow of the raw water A provided, that is to say essentially from top to bottom. On flowing through the condenser 4, a fraction as large as possible of the water vapor is condensed out of the carrier gas. The condensed water is collected at the base of the condenser 4 and taken off as pure water F. The carrier gas D dehumidified in the condenser 4 is recirculated from the condenser 4 back into the evaporation zone 8.

In the embodiment shown in FIGS. 5 and 6 the carrier gas stream is enriched with water vapor in two stages. In the first stage, the carrier gas is passed countercurrently to the raw water in the torus. In a second stage, solar heating is used for heating not only the raw water but also the carrier gas, which enriches the carrier gas with water vapor particularly efficiently.

To increase the mass and heat transfer between raw water and carrier gas, suitable internals for increasing the transfer area can be provided in the torus. Concerning the use and suitability of internals, what has been said above also applies here.

The embodiment shown in FIGS. 5 and 6 is particularly suitable both for use on a large body of water at some distance from a coast and for the water supply on (small) islands.

1. A continuous process for obtaining a pure water from a raw water, the process comprising:
passing the raw water comprising a non-volatile component into a heat exchanger as a cooling medium,
supplying additional heat to the raw water,
subsequently feeding the raw water to an evaporation zone,
contacting a carrier gas suitable for water vapor with the raw water in countercurrent flow in the evaporation zone to add water vapor from the raw water to the carrier gas, and to obtain a water vapor-loaded carrier gas,
subsequently removing the raw water from the evaporation zone,
feeding the water vapor-loaded carrier gas to the heat exchanger and cooling the water vapor-loaded carrier gas in countercurrent flow to the raw water, thereby partially condensing out the water vapor in the carrier gas, to obtain a carrier gas depleted in water vapor and a condensed water vapor,
passing the carrier gas depleted in water vapor out of the heat exchanger,
removing the condensed water vapor is from the heat exchanger as the pure water,
wherein the supplying additional heat comprises solar heating,
the supplying additional heat is in a salt water reservoir that can simultaneously serve as a heat store,
contacting a carrier gas with the raw water in the evaporation zone is substantially adiabatically, and
the passing the carrier gas through the evaporation zone and the passing the carrier gas through the heat exchanger are both by natural convection.

2. The process of claim 1, wherein the raw water is salt water and the pure water is freshwater.

3. The process of claim 1, wherein the evaporation zone comprises internals enlarging the mass transfer area.

4. The process of claim 1, wherein the carrier gas is air.

5. The process of claim 1, further comprising:
passing the carrier gas back into the evaporation zone after it leaves the heat exchanger.

6-7. (canceled)

8. The process of claim 1,
wherein contacting the carrier gas with the raw water comprises contacting the carrier gas and the raw water in two evaporation zones, and
in one evaporation zone, the carrier gas and the raw water are in countercurrent flow.

9. The process of claim 1, further comprising:
treating the pure water to obtain drinking water.

10. An apparatus for continuously obtaining a pure water from a raw water, the apparatus comprising:
a device configured to feed the raw water into the apparatus;
a heat exchanger configured to conduct a water vapor-comprising carrier gas and the raw water in countercurrent flow, suitable for condensing at least some water vapor present in the carrier gas, and configured to heat the raw water;
a salt water reservoir as a device for heat supply, configured to further heat the raw water after heating in the heat exchanger;
an evaporation zone configured to contact the raw water from the device for heat supply and the carrier gas, to enrich the carrier gas with water vapor, and to provide the carrier gas as water vapor-comprising carrier gas into the heat exchanger;
an outlet device configured to let out a concentrated raw water from the evaporation zone;
a take-off device configured to remove the pure water from the heat exchanger,
wherein the apparatus is configured to transport the carrier gas by natural convection through the evaporation zone and thereafter through a condensation zone.

11. The apparatus of claim 10, wherein a gas loading factor F is from 0.1 to 10 Pa^{1/2}.

12. The apparatus of claim 11, wherein the gas loading factor F is from 0.5 to 5 Pa^{1/2}.

13. (canceled)

14. The apparatus of claim 10, wherein the device for heat supply is configured to heat by a process comprising solar heating.

15. The apparatus of claim 10, wherein the evaporation zone is a saturator with internals.

16. (canceled)

17. The apparatus of claim 10, further comprising:
a solar transmitter separating at least some of the salt water reservoir from the open atmosphere.

18. A drinking water or a service water, comprising:
pure water obtained by a process comprising the process of claim 1.

19. The apparatus of claim 10, wherein the salt water reservoir is a natural lake or an artificially constructed pond.
